(19) United States
(12) Patent Application Publication
(10) Pub. No.: US 2003/0191765 A1
(43) Pub. Date: Oct. 9, 2003

(54) Method of graphically defining a formula

(76) Inventors: Christopher Ian Bargh, Scarborough (AU); Gregory Owen Johnston, Bicton (AU); Russell Benedict Jones, Subiaco (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/362,485

(22) PCT Filed: Aug. 24, 2001
(86) PCT No.: PCT/AU01/01053

(30) Foreign Application Priority Data
Aug. 24, 2000 (AU) PQ9664

(51) Int. Cl. G06F 7/00

(52) U.S. Cl. 707/100

(57) ABSTRACT

A computer-implemented method of graphically defining a formula, includes providing a first operator object for defining a method of manipulating at least one input to produce at least one result. A graphical representation of the first operator object is displayed. A variable object for containing data is provided. An input from a user to relate the variable object to one of inputs or one of the results of the first operator object is received. A graphical representation of the first variable object and its relation to the operator object is displayed. A logical description of the relationship between objects is recorded thereby defining the formula.

### FIELD OF THE INVENTION

The present invention relates to a method of graphically defining a formula for manipulating input data to produce a result. Preferably the method is embodied in the form of a computer program.

### BACKGROUND OF THE INVENTION

It is common for complex manipulation of data to involve many complex formulae. Often a model that provides a multilevel approach to representing the manipulation of the data is useful to define the formulae. It can often be difficult working out the formulae needed for each level of the model. It can also be helpful to this process if the formulae can be represented and defined graphically.

U.S. Pat. No. 4,901,221 to Kodosky et al discloses a graphical system and method for modelling a process. The method disclosed allows a user to construct a diagram using a block diagram editor such that the diagram created graphically displays a procedural method for accomplishing a certain result. As the user constructs the data flow diagram, machine language instructions are automatically constructed with which characterise an execution procedure which corresponds to the displayed procedure. A user can create a text based computer program solely by using a graphically based programming environment. A limitation of this method is that it relies upon iteration control for producing each output that is the result of a function of data applied to an input variable at any given time. It also relies on assembling on a screen a data flow diagram including an iteration icon that references an iteration control means for controlling multiple iterations of data flow.

It is desirable when designing the model not to be concerned with iterations of data particularly when designing an object orientated model.

### SUMMARY OF THE INVENTION

An object of the present invention is to provide a method of graphically defining a formula.

According to a first aspect of the present invention there is provided a computer-implemented method of graphically defining a formula, said method including:

providing a first operator object for defining a method of manipulating at least one input to produce at least one result;

displaying a graphical representation of the first operator object; providing a first variable object for containing data;

receiving an input from a user to relate the variable object to one of the inputs or one of the results of the first operator object;

displaying a graphical representation of the first variable object and its relation to the first operator object; and

recording a logical description of the relationship between the objects;

whereby the formula is defined by the logical description.

According to a second aspect of the present invention there is provided a computer-implemented method of graphically defining a formula, said method including:

providing a first variable object for containing data;

displaying a graphical representation of the variable object;

providing a first operator object for defining a method of manipulating at least one input to produce at least one result;

receiving an input from a user to relate one of the inputs or one of the results of the first operator object to the variable object;

displaying a graphical representation of the first operator object and its relation to the first variable object; and

recording a logical description of the relationship between the objects;

whereby the formula is defined by the logical description.

Preferably the method further includes the steps of:

providing one or more further variable objects;

receiving further inputs from the user to relate each further variable object to one of the inputs or one of the results of the first operator object;

displaying a graphical representation of the further variable objects and their relation to the operator object

Preferably the method further includes the steps of:

providing one or more further operator objects;

receiving further inputs from the user to relate each variable objects to one of inputs or one of the results of the further operator objects;

displaying a graphical representation of the further operator objects and their relation to the variable objects.

Preferably each variable object is selected from: an input object for providing data from a data source; an output object to provide data to a data destination; or a connection object for passing data from one operator object or another. Preferably a connection object represented as a link between the operator objects. Preferably each variable object may be provided with a variable label. Preferably each operator object may be provided with a operator label.

Preferably, the logical, description of the formula is defined by the logical relationship between the objects. Preferably a graphical definition of the formula is recorded that defines the graphical display of the relationship between objects.

Preferably the method includes the step of storing information describing the logical definition. Preferably the method includes the step of storing information describing the graphical definition.

Preferably, two or more related operator objects may be grouped such that the grouping defines a grouping operator object, wherein variable objects crossing the border of the grouping and connecting to inputs of operator objects in the group become the inputs of the grouping object component and variable objects crossing the border of the grouping and connecting to results of the operator objects in the group become results of the grouping operator object. Preferably inputs and results of operator objects in the group not linked to another object become inputs and results, respectively, of the grouping operator object. Preferably the graphical representation of the grouped objects is replaced by a graphical representation of the grouping operator object and the graphical representation of links to the contents of group are replaced with graphical representations of links to the representation of the grouping object.

Preferably the logical definition of the formula defined includes the contents of the grouping operator object. Preferably the graphical definition of the overall formula displayed excludes the contents of the grouping operator object. Preferably the contents of the grouping operator object may be graphically represented separately from the overall graphical representation of the formula.

Preferably, variable objects may be attributed with properties that define the type of data they can hold. Preferably each input and result of an operator object may be attributed with properties that define the type of data that the operator object expects to receive and be able to produce, respectively.

Preferably, a variable object may inherit the properties from the properties of another variable object that has already been defined and is related by an intervening operator object. Preferably, a variable object may inherit the properties from the properties of an operator object input or result that has already been defined and to which it is related. Preferably, an input or result of an operation object may inherit the properties from the properties of a variable object that has already been defined and to which it is related.

Preferably, the method includes a step of checking that the properties of objects with already attributed which are being related match.

Preferably a library of labelled variable objects is predefined. Preferably a library of labelled operator objects is predefined, each labelled operator object's method of manipulating its input/s to produce its result/s also being predefined.

Preferably the variable label of a variable object may be selected from a list of predefined variable labels. Preferably each variable label may be attributed with properties that define the type of data a variable object labelled with the label can contain. Preferably the selection of a variable label attributes the properties associated with the label to the variable object. Preferably the properties attributed to a variable object limit the selection of labels available to be selected.

Preferably, the first operator object is at least one of addition, subtraction, multiplication, division, a look-up table and conditional operation. Alternatively, the first operator object may be a multiple stage operation containing a plurality of simple operators linked to perform a more complex operator. In one form, the first operator object is a query of the database. In another form, the first operator object performs a write to a database.

Preferably the operator label of an operator object may be selected from a list of predefined operator labels. Preferably each operator label may be attributed with properties that define the type of data that inputs and results of a labelled operator object can receive or provide, respectively. Preferably the selection of an operator label attributes the properties associated with the label to the operator object. Preferably the properties attributed to an operator object limit the selection of labels available to be selected.

Preferably the logical definition may be used by a runtime engine to put into operation the defined formula, wherein data provided to each variable objects linked to an input of an operator object whereby the data becomes operands of the formula, each operator represented by the operator object becomes the operator of the formula and each result of the operator object becomes the next operand of the next operator or the final result/s of the formula, whereby computation of the formula can be conducted to produce a formula result.

Preferably a namespace may be defined for each variable, whereby the data in a logical variable represented by the variable object is the same for each occurrence of the variable object within the namespace. Preferably the name space is by default global to the formula being modelled. Preferably a logical connection is created between each occurrence of a labelled variable object within a namespace. In one embodiment a graphical link may be displayed showing the logical connection between occurrences of labelled variable objects.

Preferably a namespace may be defined for each operator object, whereby the operation of a logical operator represented by the operator object is the same for each occurrence of the operator object within the namespace.

Preferably a grouped operator object may be used more than once with the definition of the grouped operator object being applied to the logical definition of the formula.

Preferably the properties of a label include type, units and dimension.

Preferably the graphical definition is described in XML. Preferably the logical definition is described in XML.

Preferably each operator object includes a plurality of definitions of the operation performed by the operator represented by the operator object, each definition being for a separate type of data able to be manipulated by the operator.

Preferably the operator object is graphically represented as a component having one or more inputs and one or more outputs, the component having an indicator representative of the operator represented. Preferably the operator object may be an empty component that is representative of a operator with methodology of manipulation inputs to produce results yet to be defined. Preferably the empty component is used to form criteria for searching for a suitable operator object that has a suitable defined methodology.

Preferably a library of objects is provided. Preferably objects may be externally sourced.

According to a third aspect of the present invention there is provided a system for graphically defining a formula, comprising:

a computer including a display screen and a user input means;

means for providing a first operator object for defining a method of manipulating at least one input to produce at least one result;

means for displaying a graphical representation of the first operator object on the screen;

means for providing a variable object for containing data;

means for receiving an input from the user input means to relate the variable object to one of inputs or one of the results of the first operator object;

means for displaying a graphical representation of the first variable object and its relation to the operator object on the screen;

whereby the formula is defined by the relationship between the objects.

According to a fourth aspect of the present invention there is provided a computer program for controlling a computer for graphically defining a formula, said computer program causing the computer to undertake steps including:

providing a first operator object for defining a method of manipulating at least one input to produce at least one result;

displaying a graphical representation of the first operator object on a computer screen;

providing a variable object for containing data;

receiving an input from a user input means to relate the variable object to one of inputs or one of the results of the first operator object;

displaying a graphical representation of the first variable object and its relation to the operator object on the screen;

whereby the formula is defined by the relationship between the objects.

According to a fifth aspect of the present invention there is provided a computer readable medium for storing a computer program as defined above.

According to a sixth aspect of the present invention there is provided a method of graphically defining a formula for manipulating input data to produce a result, said method including:

providing at least one variable for containing data;

providing at least one operator defining the method of manipulating the input data to produce the result;

displaying a list of the variables for a user to select a result variable therefrom;

receiving a selection of the result variable from the user for containing the result of the manipulation of the input data;

displaying a graphical representation of the selected result variable;

displaying a list of the operators for a user to select an operator therefrom;

receiving a selection of an operation from the user;

displaying a graphical representation of the selected operation;

displaying a list of inputs for containing the input data for a user to select at least one input therefrom, the inputs being either said variables or one or more constants;

receiving a selection of at least one input from the user;

displaying a graphical representation of the selected input,

whereby the formula is defined by the selected result variable being equal to the manipulation of selected input(s) by the selected operation.

According to a seventh aspect of the present invention there is provided a method of graphically defining a formula for manipulating input data to produce a result, said method including:

providing at least one variable type, said variable type having predetermined properties;

providing at least one operation defining the method of manipulating the input data to produce the result;

displaying the variable types for a user to select a variable type therefrom;

receiving a selection of the variable type from the user;

receiving a name for the selected variable type;

displaying a representation of the named variable;

displaying a list of operations for a user to select an operation therefrom;

displaying a graphical representation of the selected operation;

receiving a selection of an operation from the user;

receiving input from the user so as to associate the selected variable with the selected operation so that the selected variable is either an input variable or a result variable;

where the selected variable is associated to be a result variable, receiving from the user a selection of at least one of either an input variable or an input constant and a name for the input variable or the input constant, displaying a graphical representation of the input variable(s) and/or input constant(s);

where the selected variable is an input variable, receiving a name for an output variable, displaying a graphical representation of the output variable;

whereby the formula is defined by the result of the manipulation by the selected operation of the input data in the input data variable or input constant provided to the result variable.

### DETAILED DESCRIPTION OF PREFERRED EMBODIMENTS

In order to provide a better understanding, a preferred embodiment of the present invention will be described in more detail, by way of example only, with reference to the accompanying drawings, in which:

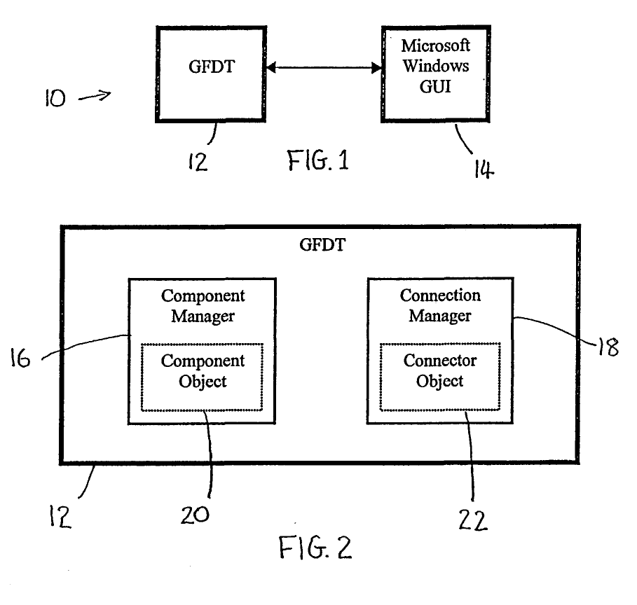

FIG. 1 is a schematic representation of a system for performing the method of the present invention, including a graphical formula definition tool;

FIG. 2 is a schematic representation of the graphical formula definition tool of FIG. 1;

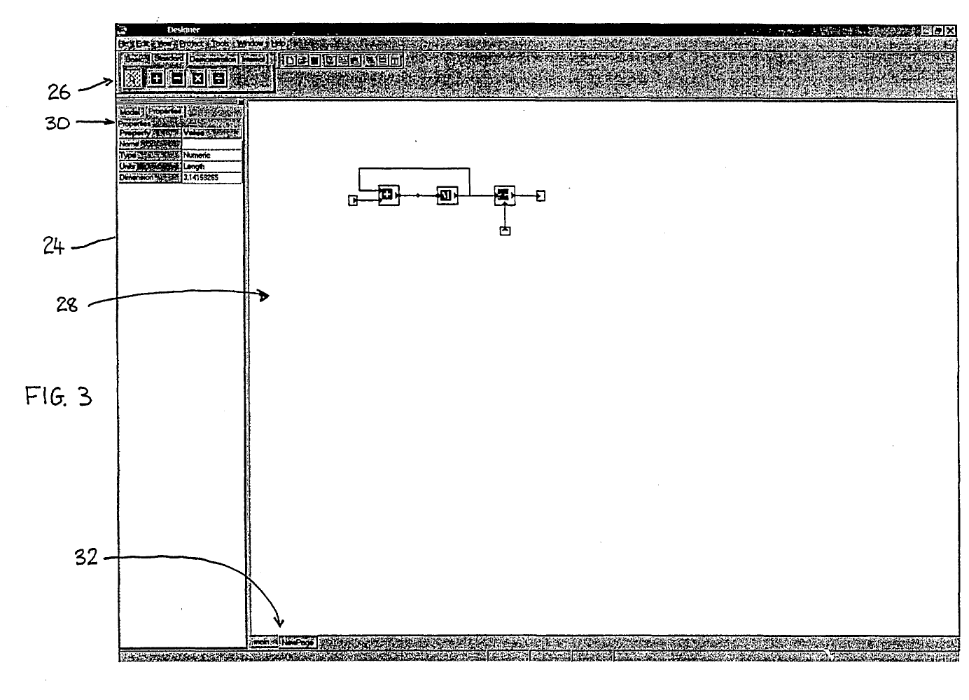

FIG. 3 is a screen shot of a window produced by the graphical formula definition tool in FIGS. 1 and 2;

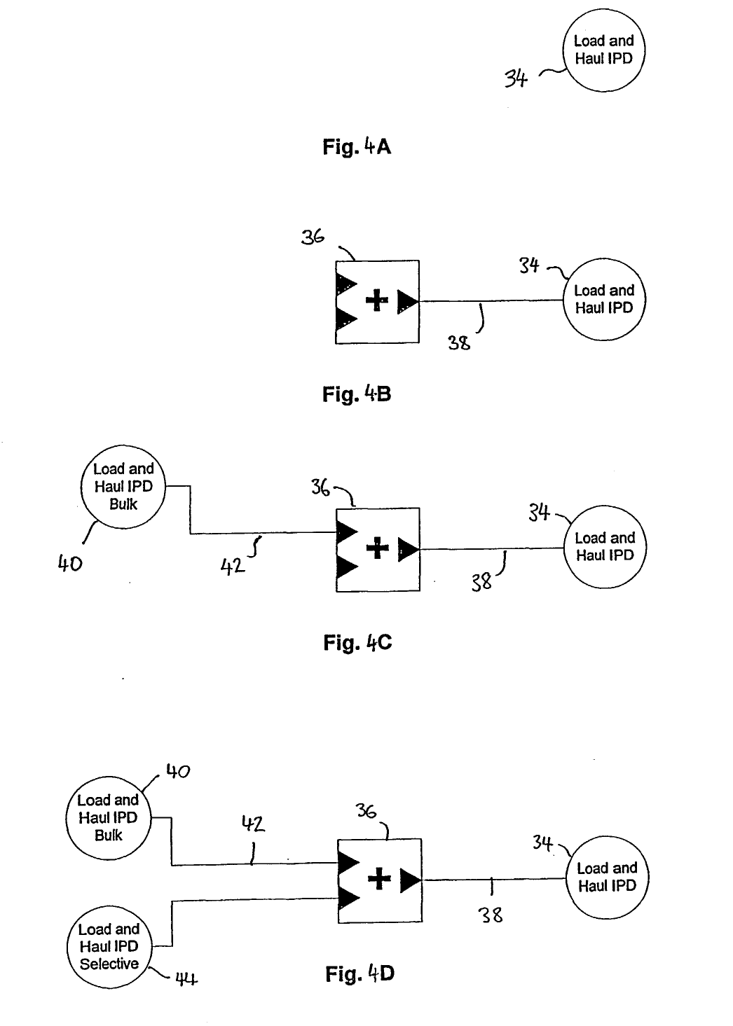

FIG. 4A is a schematic representation of a first step in a preferred embodiment of graphically representing a formula;

FIG. 4B is a schematic representation of a second step of graphically representing a formula;

FIG. 4C is a schematic representation of a third step of graphically representing a formula;

FIG. 4D is a schematic representation of a fourth step of graphically representing a formula;

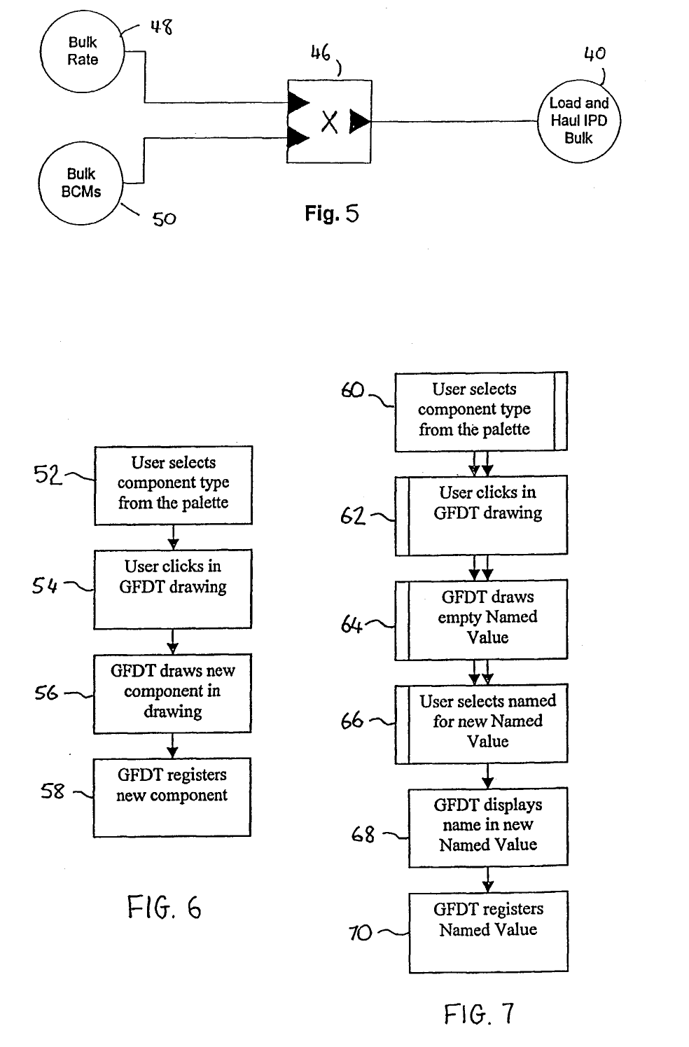

FIG. 5 is a schematic representation of a graphically represented formula;

FIG. 6 is a flow chart showing steps in the creation of a component (operator) object;

FIG. 7 is a flow chart showing steps in the creation of a named connection (variable) object;

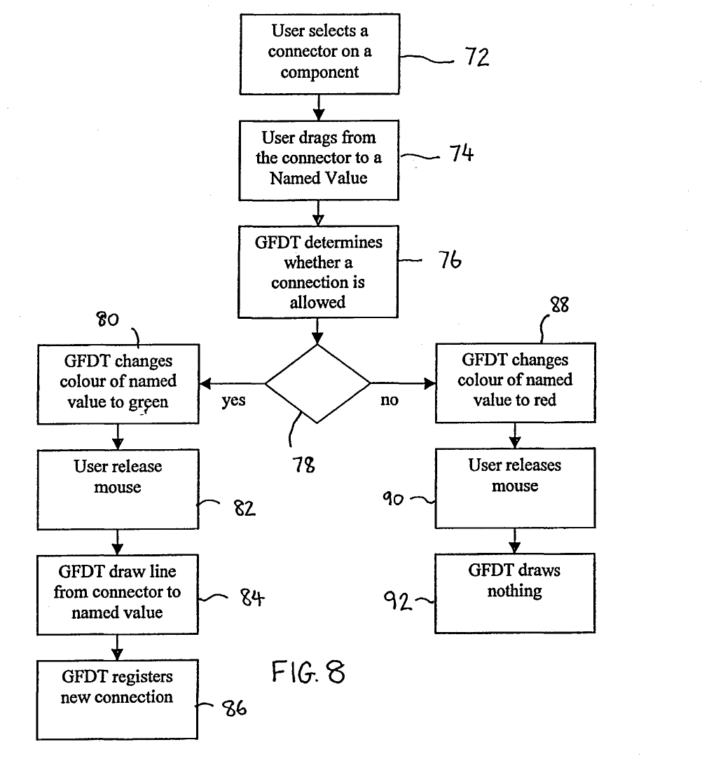

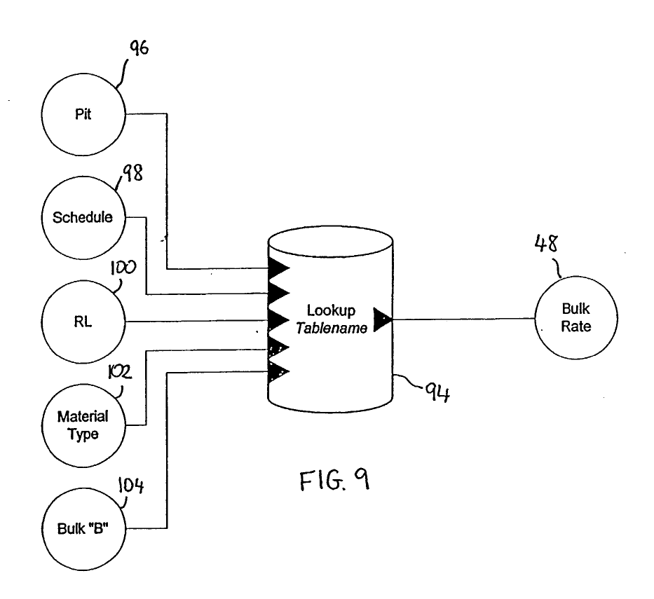

FIG. 8 is a flow chart showing steps in the creation of a connection object;

FIG. 9 is a schematic representation of a graphically represented formula;

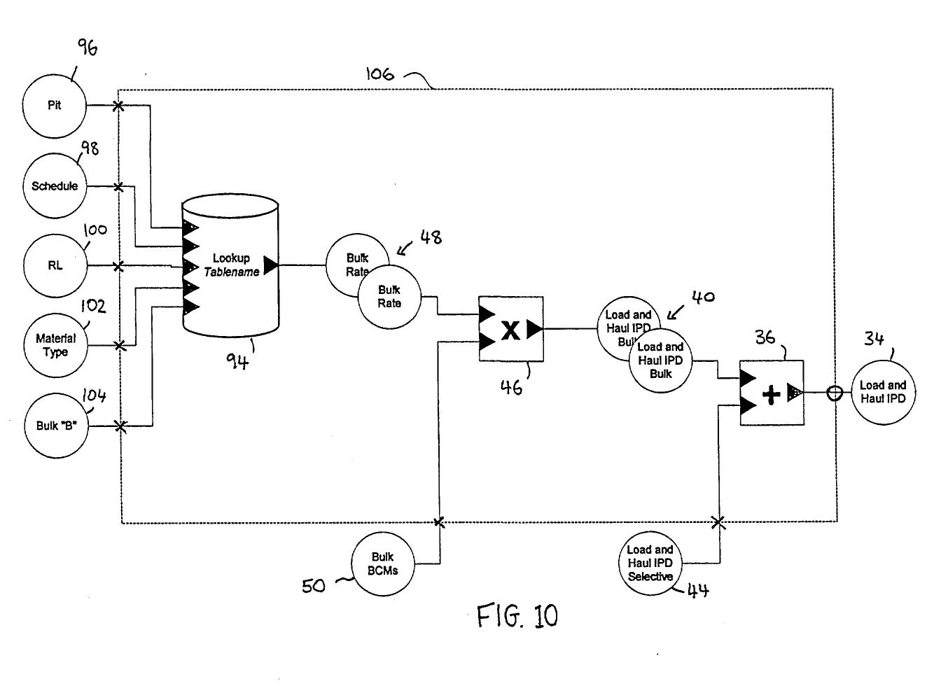

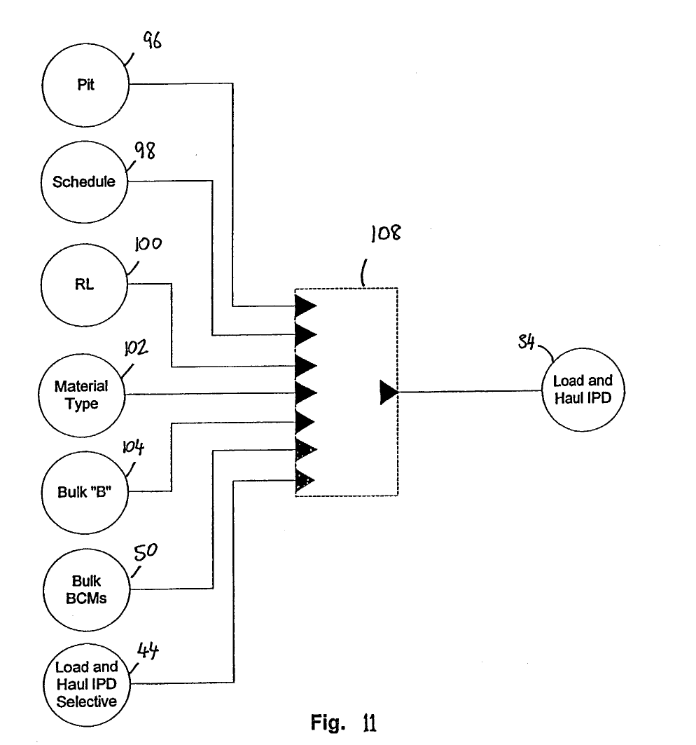

FIG. 10 is a graphical representation of the formulas defined in FIG. 4D, FIG. 5 and FIG. 9 linked together to form a high level formula;

FIG. 11 is a graphical representation of the high level formula of FIG. 10 contracted so as to not show the individual stages in the high level formula;

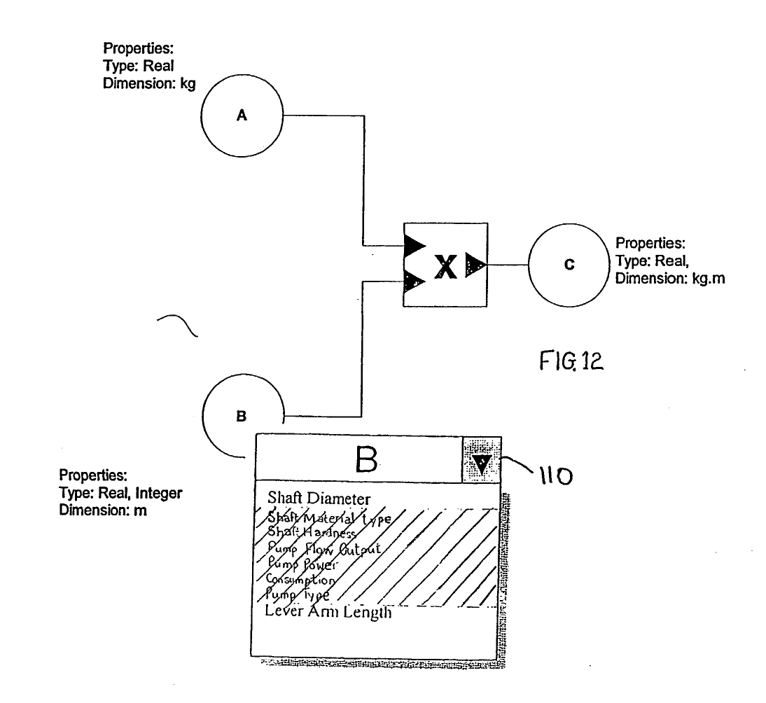

FIG. 12 shows a further example of restriction of variable types due to inheritance of variable properties;

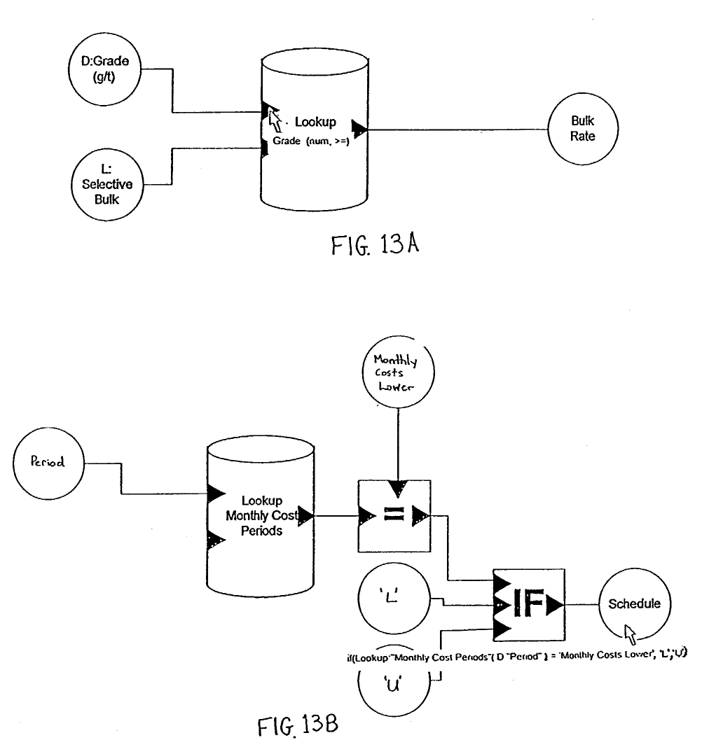

FIG. 13A shows a schematic representation of a formula with a pointer showing properties of an input to a lookup table component;

FIG. 13B shows a schematic representation of a formula with a pointer showing properties of a named variable object;

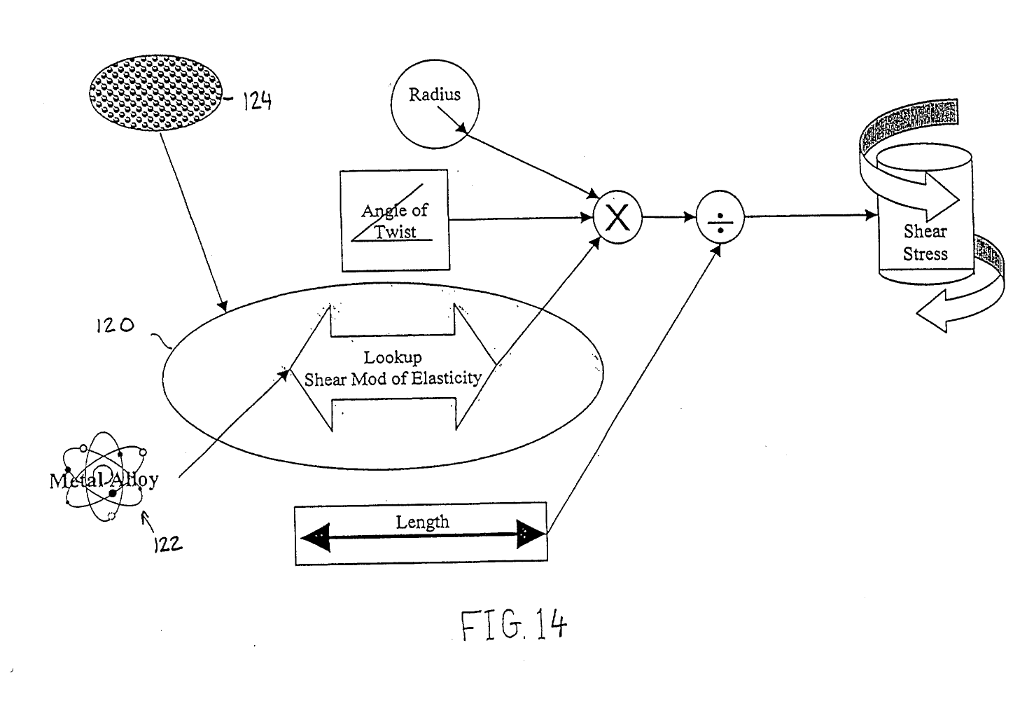

FIG. 14 shows a schematic representation of a graphically defined formula with an input variable to the formula being a database;

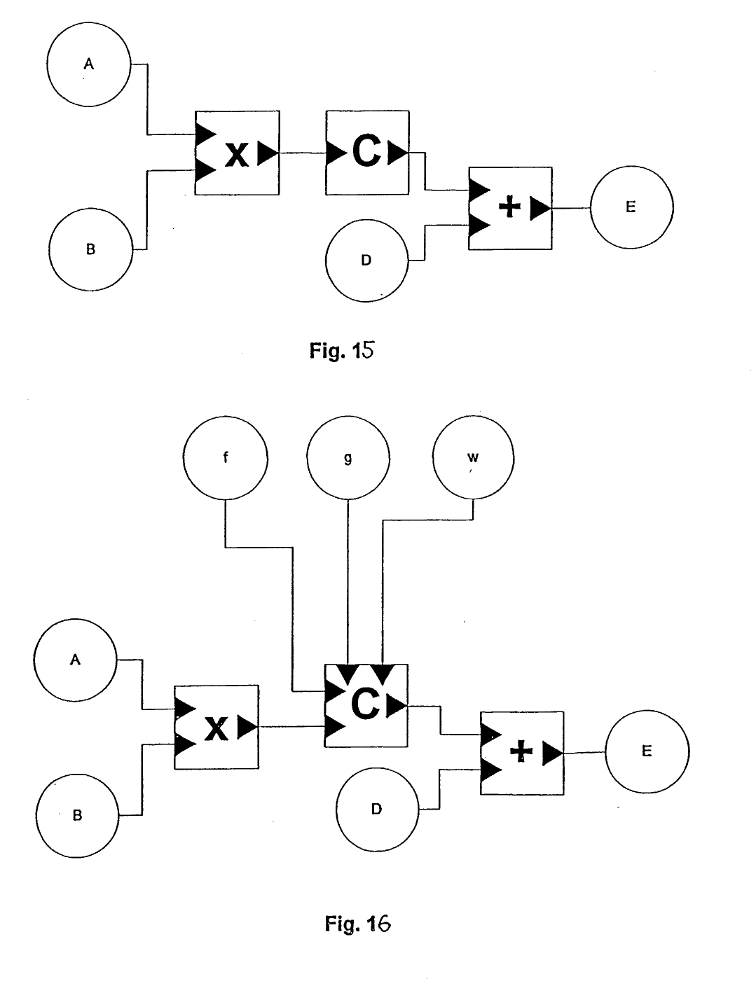

FIG. 15 is a schematic representation of another graphically defined formula including an operator;

FIG. 16 shows how the function C of FIG. 15 may be changed;

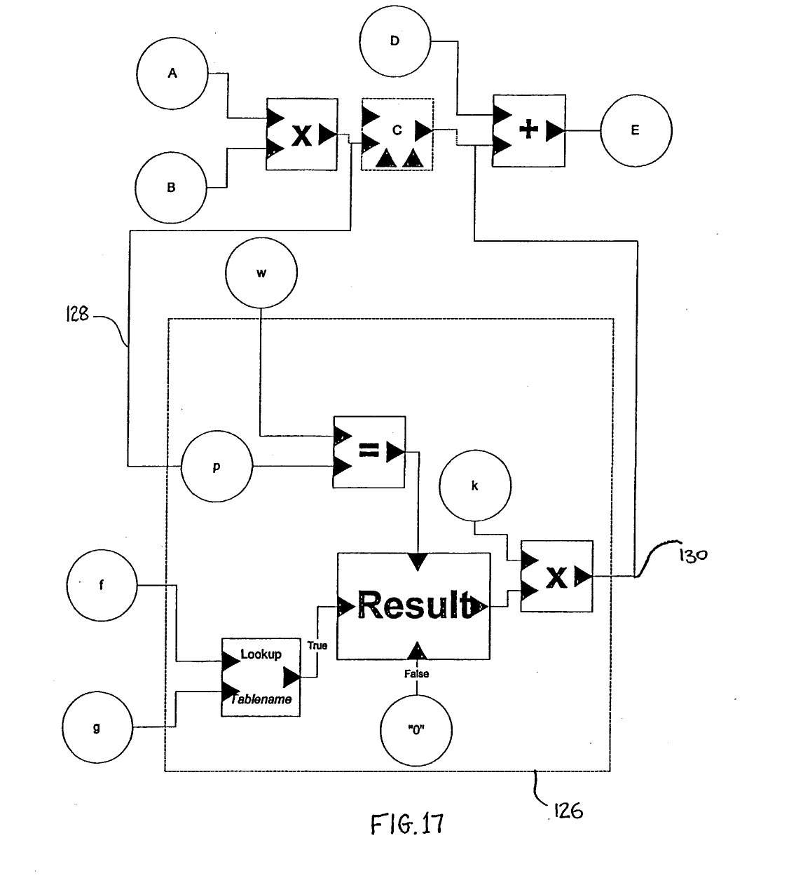

FIG. 17 shows how the function C of FIG. 12 may have additional detail added;

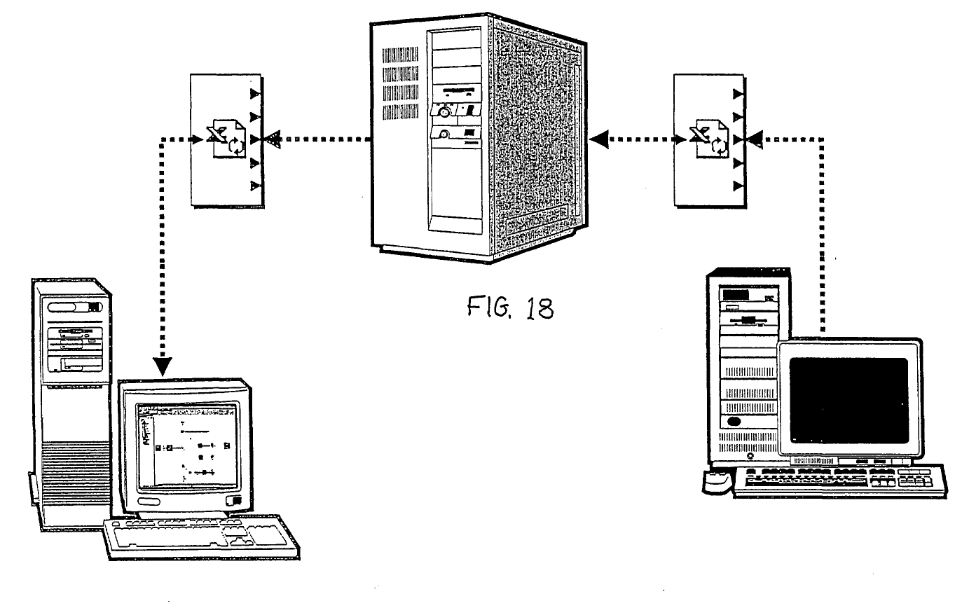

FIG. 18 shows schematic representation of a component being passed through a computer from a first computer through a computer network to a second computer;

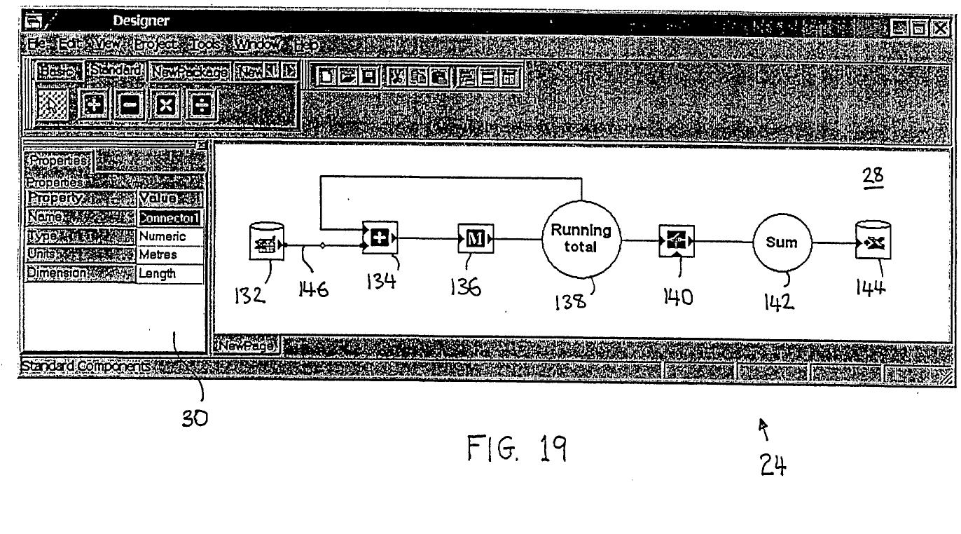

FIG. 19 shows another screen shot provided by the graphical formula definition tool of FIG. 2;

FIG. 20 provides a schematic representation of an overflow methodology performed by an operator;

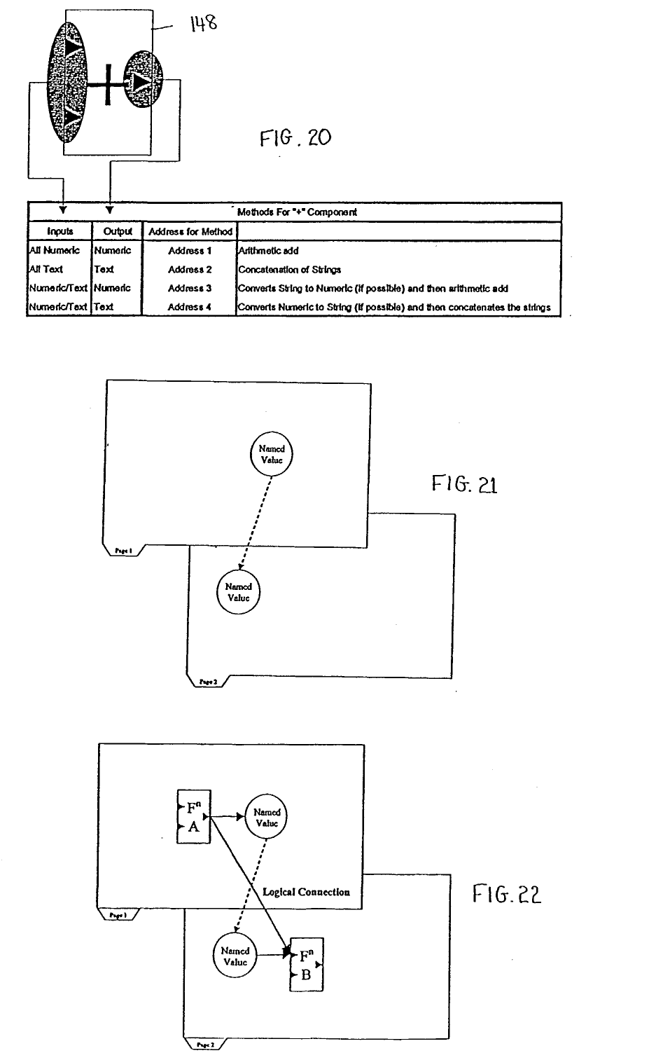

FIG. 21 is a schematic representation of logical connection between named variable objects on separate pages; and

FIG. 22 is a schematic representation of a logical connection between named variable objects on separate pages and the output of function A to the input of a function B on separate pages.

A formula is a description of a methodology for calculation of a result by applying an operator to one or more operands. Typically the operand is a variable, in the algebraic sense. The present invention defines a formula as a description in terms of operands (variables) and operators. Specifically the variables and operators have a relationship. The simple formula X=A+B, is a description of the relationship between the operands A and B and an addition operator (+). The present invention enables this to be represented graphically, which is desirable when representing complex models and functions. The present invention also produces a description of the graphical relationship defined. In other words, the relationship between the variables and operators that defines the formula.

The method of the present invention is performed by a graphical formula definition tool (GFDT) 12. Referring to FIG. 1, the GFDT 12 interacts with a graphical user interface (GUI) 14. The GUI 14 forms part of a computer's operating system, examples of which are Microsoft Windows, in its various editions, Mac OS for the Macintosh brand of computers, or X-Windows which runs under the UNIX operating system. The GFDT 12 communicates with the GUI 14 to provide instructions for providing graphical display. The actual handling of the graphical display is conducted by the GUI 14.

Referring to FIG. 2, the GFDT 12 comprises two main parts, a component manager 16 and a connection manager 18. The component manager 16 handles operator objects 20 that are provided for defining a method of manipulating at least one input to produce a result. An operator object is representative of an operator in the formula. In the present example, operators are referred to as components, thus the component manager manages component objects for purposes of the preferred embodiment.

The connection manager 18 handles variable objects. Variable objects are representative of operands in the formula for each instance of calculation of the result of the formula. Variable objects come in a number of types the main one of which is a connection object 22 that passes data into or out of a component, as will be described in more details below. Other types of variable objects are input and output objects which are generally named with a label. These are referred to in the preferred embodiment as named connections, as they are given a label that the user can refer to, to know information about the data being passed to or from a component. This will be described in more detail below.

The GFDT 12 provides to the user, via the GUI 14, with an interface that graphically represents the formula as being defined. The GFDT 12 also records a logical description of the formula as it is defined. Recording of the graphical description is separate from the recording of the logical description. The graphical description describes what is displayed on the interface. The logical description describes in logical terms the relationship between objects displayed in the interface. A screen shot of an interface 24 is shown in FIG. 3. The interface 24 is a standard Windows window, it has a tool bar portion 26, a primary window 28, and a secondary window 30. The primary window 28 displays a current page showing a portion of the overall formula. The window 26 includes a page selector 32. Other pages may be provided that show other parts of the formula. The main window 28 is shown displaying simple model for an accumulator.

The method of constructing a formula or model will be described with reference to FIGS. 4A to 4D. This example relates to a mine site. Planning, budgeting or monitoring of the mine site is conducted by using the results of calculations in accordance with predefined formulae. The formulae determine the results produced when information contained in input variables is manipulated according to a specific operator to produce the result. From the results planning, budgeting or monitoring of the operations of the mine site can be conducted. Specifically, the result of Load and Haul IPD is used as an example. Load and Haul is the cost of loading and hauling mineral bearing material out of a mining pit, in this case, In a Pit named Defiance (IPD).

Referring to FIG. 4A, the Load and Haul IPD is desired to be calculated. A variable object 34 is selected from the tool bar 26 and placed in the main window by the well known process of positioning the pointer by moving the mouse, clicking, dragging and dropping the variable object in the desired position. The variable is given the name “Load and Haul IPD”. A convention for symbols used is that named variables (labelled variable objects) are in circles, components (operator objects) are rectangular, with inwardly. pointing arrows representing inputs and outwardly pointing arrows representing outputs, and data flow connections (variable objects) are represented as lines.

The Load and Haul IPD variable 34 may be given certain properties. This is conducted by selecting the “Properties” tab in the secondary window 30 and entering the desired properties, such as it must be a numeric value, and more specifically it must be a currency numeric value and that the units of currency are AU$. The variable, once created, is graphically represented on a video display unit as a circle 34 labelled “Load and Haul IPD”. The icon of the variable will represent that it may receive data from any suitable source, such as manual entry, it may be received from another program, or it may be received from a database.

The Load and Haul IPD is calculated from “Load and Haul IPD (Bulk)” data added to the “Load and Haul (Selective)” data. That is, the Load and Haul IPD represents the cost of loading and hauling bulk material and selective material. Bulk material is from a mining method that produces mineral bearing material and non-mineral bearing material. Selective mineral is from a mining method that produces high-grade mineral bearing material.

Referring to FIG. 4B, the next step is to select a component 36 from the tool bar 26 and placing in the main window 28. Normally, a list or a number of buttons for each component are provided to the user to select from, such as addition, subtraction, multiplication, division, as shown in FIG. 3. More components can also be provided, such as look-up tables, conditional operations and other more complicated operations such as calculus, trigonometric and other operations. Additionally, data or text manipulation operations can be included. The type of operations able to be conducted should not be limited. Indeed, a vast library of operations could be made available including multi-levelled operations, which are discussed in more detail below. In this case, the “addition” operation is selected. The addition operation is graphically represented as a box 36. The addition operation has at least two (and in this case actually two) inputs and one output. A relationship between the objects is then created. In this case the “Load and Haul IPD” variable is the result of the addition, so it can be connected by selecting a connection object 38 from the tool bar 26 to draw a line 38 connecting the output arrow of the addition component 36 to the Load and Haul IPD variable 34. Thus the Load and Haul IPD becomes a result variable, by virtue of the nature of the association. The inputs and outputs are represented as arrows and the association is represented as the connection 38 between the result arrow and the variable.

Referring to FIG. 4C, another variable object 40 is selected from the tool bar 26, placed in the main window 28 and is given the name Load and Haul IPD (Bulk). Variables names may be initially entered to produce a list that the user selects the desired variable from. Otherwise, the name of the variable may be entered as required. The Load and Haul IPD (Bulk) variable 40 is associated with an input of the addition operator 36 by selecting another connection object 42 from the tool bar 26 and making a connection between the two objects. Load and Haul IPD (Bulk) thus becomes an input variable. The Load and Haul IPD (Bulk) input variable is represented as a circle 40 and the input relationship is represented as the connection 42 between the variable and the component.

Referring to FIG. 4D, another variable 44 is named Load and Haul IPD (Selective) is selected, placed and associated with the other input of the addition operator 36. The definition of the formula is now complete. The selection of the result variable, the component (operator) and the input variables and the relationship therebetween has resulted in a formula being defined as follows: input variable “Load and Haul IPD (Bulk)” and input variable “Load and Haul IPD (Selective)” are summed together by the addition operator to produce the result variable “Load and Haul IPD”. When the formula is put into operation, input data entered into the input data variables will produce a result in the result variable according to the defined formula.

In order to save the defined formula for later retrieval the type, name and properties of each object are all recorded along with the position of each object within the window 28. With this information the formula can be stored and retrieved for later display.

Simultaneously with the drawing of the block diagram formula, a logical definition of the formula is recorded. Referring back to FIG. 4A the creation of the variable object Load Haul IPD 34 is registered. In FIG. 4B the creation of the addition component 36 is also registered as it is placed. The placement of the connector 38 between the output of the addition component and the variable Load and Haul IPD is also registered. A logical connection between the result output of the component and the result variable is then recorded.

Referring to FIG. 4C likewise the creation of the variable object “Load and Haul IPD (Bulk)” 40 and its connection to a first input of the addition component is registered. Again in FIG. 4D the creation of the “Load and Haul (Selective)” selective variable and its connection to the second addition component input is also registered. The registration of the components and their connections therebetween (and thus their relationship) is therefore registered and thus a logical definition of the formula is created in the form of a description of the objects and their relationships. The positioning on the screen and other graphical information is not important to the logical description and is only recorded in the graphical description.

The graphical description is used for display of the formula to the user in a manner that the user can relate to and the recording of a logical description of the formula is used by a formula processing engine to put the defined formula to use. The user need not be concerned with the logical definition and the processing engine need not be concerned with the graphical definition. At this stage for such a simple formula the graphical definition and the logical definition are not substantially different at a conceptual level. However with more complex formula being modelled, as will be described below, these definitions will diverge. Yet the user will still be able to relate to the formula being defined at an intellectual level by the graphical representation of the formula and the formula processing engine will be able to use the logical definition without having to exclude information only relevant to the graphical representation.

An association between a variable and an operator enables the properties of other inputs of the operator to be determined, at least to some extent For example, the association of the result variable with the operator enables the properties of the inputs of the operator to be known, in this case currency numeric values. When the Load and Haul IPD (Bulk) input variable is associated with one of the inputs the properties associated with this input variable can be checked against that required by the operator. Alternatively, if the Load and Haul IPD (Bulk) input variable does not already have properties associated with it, it can inherit these properties. So, because Load and Haul IPD has the property of being a currency numeric value, both Load and Haul IPD (Bulk) and Load and Haul IPD (Selective) variables must also be currency numeric values. A check can be performed and if either input does not match the required properties a warning can issue or the association will not be allowed. Otherwise if an input does not have any properties associated, then it will inherit the currency numeric value property.

Checking and inheritance can work both ways. That is, if an input has a currency numeric value property, the result is also checked to see whether it has consistent properties. Normally, the more recently created input/result variable is the one checked.

Inputs and outputs of components hold property information relating to the component. A component is defined by the properties of its inputs and outputs along with the functionality that produces the output from the inputs.

In FIG. 5, a formula for calculating the value of “Load and Haul IPD (Bulk)” 40 is defined by multiplying the input variable “Bulk Rate” 48 by input variable “Bulk BCMs” 50. Bulk rate represents the cost for mining each in-situ cubic meter of “Bulk” mineral bearing material. Bulk BCMs represents the Bank (in-situ) Cubic Meters (BCM) of Bulk material. This formula can again be built using similar steps to define the previous formula. The “Load and Haul IPD (Bulk)” input variable 40 is able to be used as a result variable. It may therefore be selected and represented on the display. If “Bulk Rate” and “Bulk BCMs” input variables are not already available, they may be entered. The multiply operator object 48 is then selected and associated with the input variables and output variables. This may be done by dragging the representation of the multiply operator and placing it. The input and result variables are related to the operator so the input variables (“Bulk Rate” and “Bulk BCMs”) are connected to the operator inputs and the output arrow is connected to the result variable (“Load and Haul IPD Bulk”). Here the order of placement of the variables and operation is different to the previously defined formula. The order only makes a difference to order of checking properties and inheritance. If the properties of the input variables when multiplied together are not consistent with the properties of the result variable, a message may be provided to the user that there is a problem with property inheritance. That is, if the Bulk rate input variable does not have the property of currency per volume numeric value and/or Bulk BCM's input variable does not have the property of volume numeric value a warning message will be given or if one of the two have the correct property, the other will inherit the correct property. Property analysis and inheritance need not be limited to the dimensions of the variable/constant. The units of the dimension can be checked, for example, if one unit is AU$ and the other is US$, this will result in a warning. Alternatively, a conversion may be conducted as described further below.

This formula may be created on the same page as the formula of FIG. 4D or it may be created on a new page. The page selector 32 may be used to select the appropriate page if they are on separate pages. This is also where the graphical definition may begin to diverge from the logical definition, particularly if they are on separate pages. While each page will contain a separate graphical definition for each formula, the logical definition will form a connection between the Local and Haul IPD (Bulk) result variable of the formula of FIG. 5 and the Load and Haul IPD (Bulk) input variable of the formula of FIG. 4D. Thus, to the user, one formula is represented as two smaller formulae. This will aid in intellectual understanding of the formula, but logically there is no separation. This is not to say a separation cannot occur where the same named variable has a particular space within which to operate. A namespace for a variable (and a component) can be defined limiting their application. This will be described in more detail below.

The processes conducted by the component manager 16 and the connection manager 18 are now described in more detail with reference to FIGS. 6, 7 and 8. Referring to FIG. 6, a component manager 16 first allows the user to select a component type from a palate displayed in the tool bar 26 at 52. In the example shown in FIG. 3, an addition, subtraction, multiplication and division buttons are provided for the selection as components. When one of these buttons is depressed the operating system informs the component manager 16 that that particular button has been selected. The type of operator component is known. The user then clicks in the drawing window 28 at 54 which results in the placement of a component in the location clicked. This entails the component being drawn in the drawing window 28 at 56 and the component being registered in the formula definition at 58. Details specific to the graphical representation of the component are stored such as the component name, its type and the position on the page and details of the icon representing the component In the logical definition the details such as the name and type of the component are registered.

Referring to FIG. 7 when a named connection is to be included in the formula, the user selects a named connection component type from the palate at 50. The user clicks in the drawing window 28 at 62 and an empty named connection variable is drawn at 64. The user can then name the variable or wait and name it later. If it is named, a facility is provided at 66 for the user to enter the name which is then displayed in the new named connection at 68. The named connection is then registered at 70. Details related to the graphical display of the named connection are recorded such as the name, the type, the position on the page, the named connection. Logical description details of the named connection are registered such as the name, type of named connection.

Referring to FIG. 8, a connection between operator objects such as components or components and named connections is described in relation to FIG. 8. The user selects a connection option in the tool bar at 72. The user clicks on a component and drags a connector link to a named connection or another component at 74. The connection manager then determines whether the connection is allowed based on the: properties of the objects being connected at 76. If the connection is not allowed, as indicated by “no” on 78, a warning is provided by changing the colour of the line being drawn to red, alternatively the colour of the named connection may be changed to red at 88. When the user releases the mouse at 90 the drawing is not completed at 92 and thus the connection is not registered. If the connection is allowed, as indicated by “yes” on 78, the colour of the named connection is turned to green at 80. As the user releases the mouse at 82 the line representing the connection is drawn at 84 and the connection registered at 86. Details relating to the graphical representation of the connection (line) such as the end points of the line and any vertexes (bends) on the line. Details relating to the logical description are registered such as the details of the components being connected.

The processes described in relation to FIGS. 6, 7 and 8 occur for each page of the drawing. In addition, in the graphical description each drawing has a name recorded (the page name) and for each page of the drawing each registered component named connection and connection details are recorded. In addition, namespace details are recorded as will be described in more detail below.

Referring to FIG. 9, another example of formula definition is shown. In this instance the “Bulk Rate” 48 is defined by a look-up table 94 from a number of variables and constants 96 to 104. Pit 96 is a variable that represents the name of the mining.Pit. Schedule 98 is a variable that represents a mining rate that depends on the amount of mineral mined. RL 100 is a variable that represents the relative level of depth into the Pit that the mineral is taken from. Material type 102 is a variable that represents the type of material being mined, for example, it may be fresh or sediment material. Bulk “B” 104 is a text constant. The look up table 94 is an operation that looks up a value based on the values of the five inputs. The resulting value is then provided to the result variable 48. The figure shows the connections between the inputs and the outputs. The building of the relationship by the selection of the inputs, results and operators and the placement of the representations of these on the screen is recorded. The logical description of these objects and relationships therebetween defines this formula.

Referring to FIG. 10, the example described thus far has been using a top down methodology to define a model as a number of simple formulae. These formulae can be collated or the model drawn as one complex formula as shown. It can be seen that the input variable PIT 96, input variable SCHEDULE 98, input variable RL 100, input variable MATERIAL TYPE 102, input constant Bulk “B” 104, input variable Bulk BCM's 50 and input variable Load and Haul IPD (Selective) 44 are all used to calculate the final output result variable Load and Haul IPD 34. The outlined label area 106 shows that the existing multistep formula (modules) can be chained together to produce a more complicated higher level formula. The steps inside the dashed box 106 can be grouped to form a high order component. The inputs on the high order component are shown as an “X” and the output being shown as a small circle.

This high level formula could also be defined without the need for the variables “Bulk Rate” and “Load and Haul IPD (Bulk)”. Instead the output of operators 94 can feed directly in the input of operator 46, and the output of operator 46 can feed directly into the input of operator 36. In other words the operators can be directly chained together. However, it may be more suitable to design this formula as shown in FIG. 10 if the variables “Bulk Rate” and “Load and Haul IPD (Bulk)” are used elsewhere.

The componetising of a chain of operators is conducted by drawing a box 106 around the components to be componetised and selection of a componentise function. The objects within the box 106 are then deleted from the current page and shifted to a new page. The internal workings of the new component can be viewed on the new page. The graphical description of the components are copied to the new page. In place of the deleted objects is a new component 108 as shown in FIG. 11. A graphical description of the component is included in the current page description with each input into the deleted components forming an input into the new component 108. A connection from the named connections 96 to 104, 50 and 44 is created to the corresponding input of the new component 108. The connection from the output of the new component is connected to the named component 34. The description on the current page is updated to reflect the new component and the connections thereto. A logical connection is created between each of the inputs of the new component and each of the inputs of the grouped component on the other page. Likewise a logical connection is created between the output of the component and the output of the component on the other page. Thus the logical description of the model in effect remains unchanged whereas the graphical description of the model is different.

In FIG. 11, the chained operators inside 106 of FIG. 10 have been grouped together to provide a higher level operator 108. This operator 108 requires the five inputs to produce the Load and Haul IPD result variable. The new component 108 can now be reused without the need to redefine the individual lower level formula that make up the high level operator 108. A facility may be provided to show the workings of a component. This may be for example, by “double clicking” on the high level formula to open it up to display the chain inside by “turning” to the page in which the inner workings of the component are shown. This process is called “drilling down” to see the next level of the detail.

As can be seen that a top down design methodology can be used to define various formulae with the properties of each level being checked to ensure they have consistent inheritance. Equally, a bottom up design methodology could be adopted. This allows for a multi-level model to be created, which can be graphically represented and defined. Modular building of higher level functions can also be conducted.

Referring to FIG. 12, inheritance can be used to restrict the options of variables/constants available for selection. That is, if due to the selection of another variable, the variable being selected must have certain properties the selection of the variable may be restricted to those variables that have the required properties. Other variables can be “greyed out” and made unavailable for selection or simply not displayed in the list of options. An example of property inheritance is dimensional inheritance. In this case each variable must have at least one dimension, for example distance, time, mass, etc.

In the example provided in FIG. 12, the formula being defined is: A×B=C. The variables are given properties including type, dimension and units. In this case, the result variable C is a real variable and has a dimension of mass.distance and units of kilogram meters (kgm). A has the properties of a real number with its dimension being mass and units kilograms (kg). B has been defined with the properties of being either a real or an integer number. This may have been the result of defining the properties of A and C by virtue of inheritance B must be either a real or an integer number. If, for example, C had been defined as an integer and A had been defined as an integer, then B would, out of necessity, have been an integer. In addition, because C has the dimension mass.distance (kgm) and A has the dimension mass (kg), by necessity, B must have the dimension distance (m). Likewise, if A and B had been defined first, A being kg and B being m, C out of necessity would have had to have been kgm by virtue of the dimensions and units of each of the inputs and the effect of the operator.

Since B has the properties of being a real or an integer number and the dimension is in metres, the actual variable type meeting those inherited properties will restrict the type of input variables that B may be. A pull down menu 110 is shown that lists a number of variables types that have been previously entered. Variables types that meet the properties are shown in a normal font and variables not meeting the properties are shown “greyed out”. Of course, an alternative may be to simply not display the variable types that are not available for selection.

In this case, the variable type “SHAFT DIAMETER” or the variable type “LEVER ARM LENGTH” may be selected. Whichever of these variables types is selected from the pull down menu will then become the variable type of the variable B. The variables able to be selected from may be obtained from a variety of sources, such as databases or a library of variables, and not just manually entered. The pull down menu may contain a list of textual variable names, as shown, however icons representative of the variables may also be used in the pull down menu. Other suitable selection means may also be employed.

The same process can apply to other input variables such as A, as well as, result variables such as C. The order of selection of the variables will necessarily determine the properties of subsequent variables (or constants).

To check the progress of the definition of the formula, a facility may be included where a pointer is placed over a part of the formula being defined and a window will appear that displays the formula defined thus far (as shown in FIGS. 13A and 13B).

In FIG. 13A, it can be seen that the pointer is placed above one of the inputs of a look up table. Beneath the pointer, a box appears that shows that the properties of the input needs to be a “Grade”, which is a number greater than or equal to zero. It can also be seen that grade is given the property of grams per tonne.

In FIG. 13B, the pointer is shown pointing to Schedule result variable, which shows the definition of the formula thus far. In this case, the formula so far defined is: if look up table: “monthly cost periods” with the data in the variable: “period” equals “monthly costs lower” value), the result is the lower value (L), otherwise the result is upper value (U). It is also possible to check the syntax of the formula entered.

Referring to FIG. 14, in this example the formula for shear stress is defined. “SHEAR STRESS”=(“RADIUS”×“ANGLE OF TWIST”×“SHEAR MODULUS OF ELASTICITY”)÷“LENGTH”. In this example the icons that represent the objects displayed are different. Shear modules of elasticity 120 is a look up table operator that receives an input, which is a metal alloy input variable 122, into which data is received. The look up table may be a component that references data stored within the GFDT. Alternatively the look up table may be a component that references external data. For example, the external data may be in the form of a spreadsheet. The GFDT can be provided with a plug-in that enables data to be transferred from external software applications. A typical spreadsheet application would be Microsoft Excel. The GFDT, via the plug-in, can communicate with Excel to retrieve data in an Excel spreadsheet. The look up table may be derived from data supplied by a material supplier regarding the sheer modulus of elasticity for each metal alloy. The data may be sourced from a number of material suppliers. The data may be sourced from a database 124 provided by the material supplier. The database may be accessed through a computer network, such as the Internet. Therefore, the operator 120 may involve a database query that accesses the database 124. The database 124 may be a distributed database. Thus, the method of graphically defining a formula may also be used to define a database query, with a database query being a particular type of formula defined in accordance with the present method.

Referring to FIG. 15, in this example the result variable E is defined as: E=C(A×B)+D, where C is another function. If C has not been defined it is referred to as an empty component. The properties of C may be defined by other properties of the formula shown in FIG. 15. That is, the variables A, B, D and E will, to some extent, define the properties that the input and the output of the operation C must have. C can also be progressively defined so that if it is desired to add further inputs “f”, “g” and “w” into C as indicated in FIG. 16, these can be added as the formula is progressively defined. When it is desired to add a new input to the component C a selection to add an input to the component is selected and a new input or output created as desired. Thus further named variables “f”, “g” and “w” can then be connected to the respective inputs of component C. Likewise, additional output can be added as required.

When it is desired to specify the functionality of the component C, C can be opened by drilling down to the next level as indicated in FIG. 17. Another layer of functionality of C is defined as indicated in the box 126. Alternatively functionality of C may be drawn from a library of components. A basic library may be provided with the GFDT. Alternatively a library may be provided on-line. A component that fulfils the requirements can be searched for through the Internet. Once a component that fulfils the requirements is found it may be inserted into the formula. As shown in FIG. 18 a component residing on a different machine is found that fulfils the properties required of the component and performs the required functionality as described in a description attached to the component and this can be forwarded through a computer network such as the Internet to the local instances of the GFDT for insertion into the formula being created.

Referring to FIG. 16, it can be seen that C is a function of the product of A and B and also receives the inputs f, g and w. That is C=(A×B, f, g, w). Referring to FIG. 17, when C is “drilled down” it can be seen that the product of A×B is connected by connector 128 to a temporary variable “p” which is then compared to. the input variable “w” as indicated by the equals sign (“=”) operator. The RESULT operator tests to see if the comparison is true, in which case the result of the LOOKUP table, which receives inputs “f” and “g”, is provided. Otherwise, if the comparison results in false the result is “0”. The result of the RESULT operator is then multiplied as indicated by the multiplication operator (“×”), with a constant “k” and then provided to the output 130. This is then provided to input the addition operator (“+”) where it is added to the variable D to provide the result E.

Empty components can be provided as a place holder for a fully defined component. An empty component is yet to have its functionality between its inputs and outputs defined. The user can place an empty component in a design environment and define its inputs and outputs. The functionality of the component can then be defined later as required or the definitions of the inputs and outputs can form a search criteria for searching for components that can perform the function from a library. Further search criteria can be provided such as key words, higher class level structure information and so on. Empty components further assist in top down design methodologies.

It is desirable to use colour coding to assist in the graphical representation. For example, one colour, say blue, can represent variables. Another colour, say green, can represent operator and yet another colour could represent constants. Input can be shaded lighter, say light blue, and outputs shaded darker, say dark blue. This assists in visualising the representation of the formula, particularly when complex multi-level formulas are represented. Other visual representations, such as icons can be used to represent variables, constants and operators, such as is used in the figures.

Many of the objects in a GFDT model will be provided with properties that the user can view and/or modify. As shown in FIG. 19, an accumulator component is defined that accumulates an input received 132 from an Excel spreadsheet. The discrete output from the spreadsheet 132 is added to the last sub-total (Running Total) by operator 134 and stored by memory operator 136. Then at the end of a row of data from the spreadsheet, the result from the “Running Total” variable 138 is gated by gate 140 to a “Sum” variable 142 which then passes it back into another spreadsheet 144. The 146 connector is shown highlighted. In the secondary window 30, properties of the highlighted object are shown. The properties of a highlighted connector 146 are that its name is “Connector 1”, it is of a “numeric” type and it provides units in “metres” for the dimension of “length”. A wizard can be provided to assist in the selection of properties for objects in a similar manner to that provided in products such as Delphi or Visual Basic. A number of predefined data types may be provided which can then be further extended by the user depending on their needs. Or the user may buy or obtain a library of extended data types. For example a data type that relates to complex numbers may be represented as two independent numbers being the real and the imaginary components of the complex number while in another example the output of an engine might be represented by power, torque and angular velocity as sub-components of the general data type “output of an engine”.

In FIG. 19 the user can change values of the properties simply by editing the values of the fields or by making a selection from a drop down list.

Complex data types will also need to define the operations that can be performed on them. Operators may use existing components as the representation in the model. For example, the addition of complex numbers requires a different set of operators from the addition of real numbers. They both can be represented by a “plus” component however the way in which the component deals with the data type depends on the nature of the data type. When a connection is made to a component a negotiation process takes place whereby where ever there are existing properties of a connector data type or input or output of an operator or named connection, the data type connection must be consistent. Thus through a process of negotiation between each of the objects a correct data type can be selected.

Referring to FIG. 20, an addition component 148 may be able to perform several methods of addition depending on the data type. This is known as data overloading. The data type may be provided with an intrinsic methodology for dealing with different types of data as indicated in the table, however additional methodologies of dealing with different data types can be provided. Predefined schema defining the format for adding additional definitions can be provided so that further data types can be added and dealt with by components.

Where data is provided in a particular type of unit often in many cases a conversion factor may be required, for example one unit may be in seconds and another unit may be in minutes for the same dimension of time. Conversion may then be required. A conversion factor may be required again to convert for example a speed in kilometres per hour into metres per second. Further, dimensional definitions require the combination of fundamental dimensions of a unit. The fundamental definitions being length, time, mass, charge etc. For example, acceleration is length×time⁻². Other properties may also be provided to objects. Examples of other properties include security information—such as the type of user that can use the information and encryption information; version information—the version number and how long the version is valid for, certification information—the data type function identified as coming from a certified source; charging information—for use in pay as you use and subscription access to data or objects; location information—such as an IP address and file name for the location of data or objects; and broker information—information on the manager of a component.

Each model, named connection and component definition will have its own namespace. This means that the names of particular objects used in a particular model or component definition are unique to that model or component. Objects in different models or different component definitions, especially named connections, sharing a common name are not the same object. However the namespace can be modified. This is akin to local variables in many programming languages where the name of the variable only applies within a particular space. This is to prevent two objects that have the same name but are unrelated being confused for one another.

Some operations are extrinsic, meaning that they are performed outside the formula engine. They are performed by making a call usually through an application specific plug-in to the external component along with any input required, whereupon the result is fed back to the engine (via the plug-in) for further computation of the formula. Extrinsic components are made available in the GFDT by importing a component type definition file. This then provides a definition for the component for use by the GFDT. A component type will typically have a set of input and output connectors which a component may then be created according to the component type.

When componetising a group of components all the connections that lead outside the component will create input Input and Output objects for named component, if a named connection is used anywhere outside the component. If a named connection is only used inside the component then the name space of the named connection will become the component It will no longer be available outside the component This method provides a manner for hiding detail and forces a user to follow a more structured approach when building a model. Complex components are effectively functional blocks with well defined interfaces. The user then finds it difficult to build “spaghetti code” models as defined interfaces and functional blocks are provided.

Some components are extrinsic components, such as Microsoft Excel word spreadsheet. This can be wrapped into a GFDT component and used when defining a model. When the definition is executed to calculate the formula it actually uses the Excel spreadsheet. The engine will communicate with the spreadsheet via Excel in order to pass data into and out of the component Remote components execute in a different engine from the main model. From the point of view of the local function engine they are “black boxes” with the internal workings unknown.

Where a connection is desired between two elements, such as components, a named connection can be placed on the page and assigned a label. Properties can then be assigned to the named connection. The named connection does not have to be connected another object at this stage but can be used elsewhere by placing another named connection object on the design page and selecting the same label, such as from a drop down list. This will not create a new object but rather allows a second instance of the same object to exist, provided the second instance is in the same namespace as the first. As indicated by FIG. 21, a logical connection between the two named connections is formed so that when a connector of another object such as a component is connected to the named connection, every instance of the named connection can inherit the properties of the component. Likewise, when data is provided to the named connection in one location it will also be provided at the other location because of the logical connection. Furthermore other instances of the logical connection will transfer the properties to other components or connections that are related to the named connection. Typically named connections are used to identify incoming data and outgoing data as well as intermediate values in the model. A named connection is akin to a variable in a convention software programming language in that it may appear in many places in the model and carries a value which it may vary during the execution of the code. An assignment of a value to a named connection or an input of an operator can only be done in one place because the value is passed on to the other instances of the named connection. Therefore only one output connection is allowed to be connected to an input of an operator or a named connection.

Referring to FIG 22, where a component A provides an output to a named connection on one page and then on another page the named connection provides an input to component B the effect is the creation of a logical connection between the output of component A and the input of component B. A logical connection is in essence a communication of data through various components of the model. In terms of the logical definition, named connections are irrelevant as it is purely a meshed network of components and connections therebetween.

During the connection of two objects checking, matching and adoption takes place. For example, if dimensions have been defined for both connections then they must be the same in order for the connection to be allowed. Units need not be identical as long as a conversion factor can be determined. If any of the properties are undefined at either end then they can be adopted or a different property can be discarded in order that the properties remain consistent. Once a consistent data type has been negotiated between the connections there is then a check performed to see that the component has functions available to work with the data type. If there is not then there is a check to see whether any converters may be made to make then compatible. For example, a number may need to be converted into a text string.

It is to be noted that an output may be connected to many inputs and thus negotiation may not simply be between two connections. Each time another input is added to the set of connections further negotiations will take place to ensure that the data types are consistent and if necessary a data type may be changed to accommodate the new connection. The component manager will search a set of available overload functions, those that work with possible data types. In addition, available data converters may be checked to see whether the data can be converted to an acceptable data type. If this is not possible then the connection manager may try to renegotiate with the components that a connection connects to. This can lead to all the properties of connections being renegotiated in the entire model. However the user may be able to limit the extent of this process by defining a distance from a new connection that negotiations are allowed to proceed over.

Referring back to FIG. 19, the accumulator.model receives data from an input spread sheet. This component represents an Excel spread sheet containing a column of numbers. Each number is represented on the output connector sequentially, with the next one becoming available only once all the connections have used the previous value. This component is connected to an input of a addition component. The other input is connected to a “Running Total” named connection. The output of the addition component is connected to a memory component that maintains at its output the value presented to its input. All other components reset the outputs (to undefined) for each iteration of data from the input spread sheet. The output of the memory component is provided to the named connection “Running Total” that represents an intermediate “Sum” during the calculation. The “Running Total” named connection is provided to an input of a switch component This component blocks the transfer of the input value to the output connector until the value at a gate input connector (on the bottom) is true or there is no more data. In this way the output only shows the sum of the calculation not any intermediate values. The output of the switch component is provided to a “Sum” named connection. This value represents the sum of the accumulation which is written to the output of an output spread sheet. The output spread sheet represents another Excel spread sheet to which the result of the calculation will be written. In Appendix 1 an example of an extensible mark up language (XML) description of the formula defined is shown. It is noted that a section of data relating to the definition of icons is not shown. This defines the recorded description of the formula as shown in the window. In Appendix 2 a logical description in XML is shown that defines the components and the connections thereto.

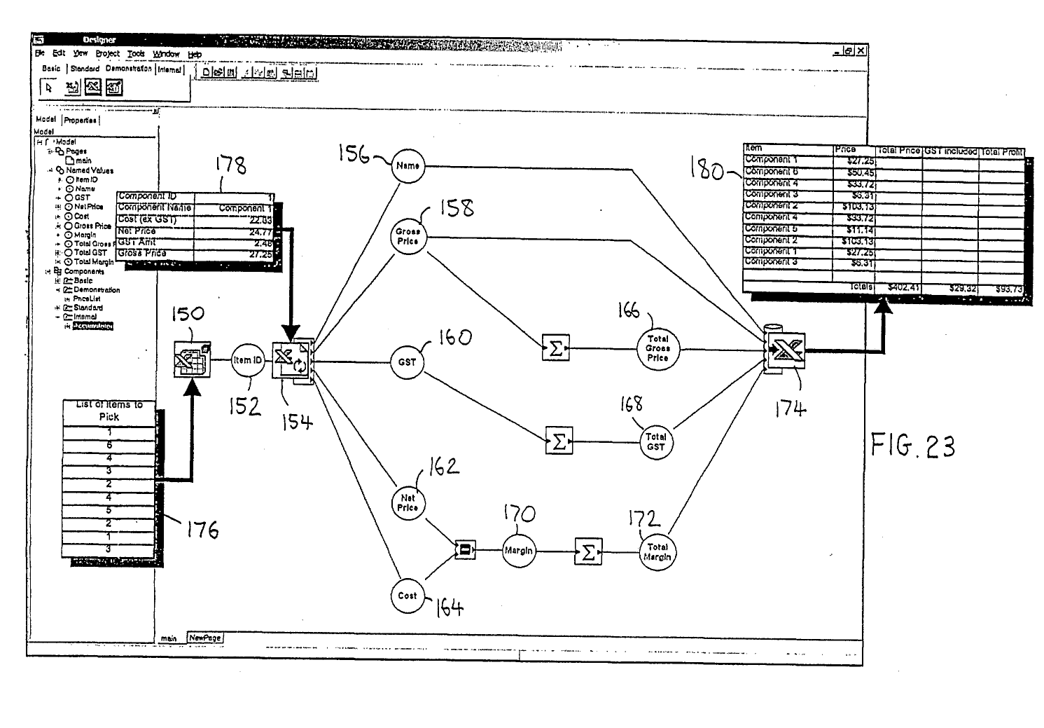

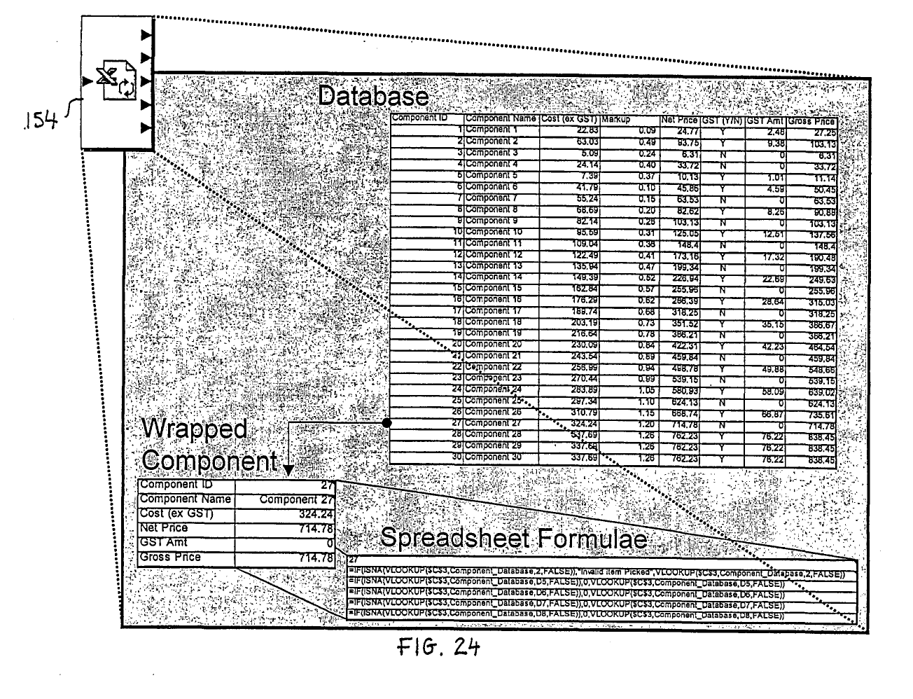

Referring to FIG. 23, a more complicated formula is shown which receives data from a spread sheet 150 of “List of Items to Pick” which is provided to a named connection “Item ID” 152. This is then provided in turn to a look up component 154 that looks up the Name, Gross Price, GST, Net Price and the Cost of each item within a spreadsheet. The spreadsheet is shown in FIG. 24 which forms the basis of a wrapped component with the values of each of the outputs being calculated by a spreadsheet formula being based on a database table of 30 components. Further calculations are performed on the “Name” 156, “Gross Price” 158, “GST” 160, “Net Price” 162 and “Cost” 164 by summing the “Gross Price” to produce a “Total Gross Price” 166, summing the “GST” to produce a “Total GST” 168, determining the “Margin” 170 by subtracting the “Cost” from the “Net Price”, summing the individual “Margin” to produce a “Total Margin” 172. Then the “Name”, the “Gross Price”, the “Total Gross Price”, the “Total GST” and the “Total Margin” are provided into another Excel spreadsheet 174. The processing of the formula can be seen by entering values 176 into the first spreadsheet 150. In processing this formula each item ID is used to retrieve data on the item using the database retrieval component which provides outputs as each item is processed and another entry is created in the final database 154 as can be seen by 178. The result of the calculation 180 is returned to the final spreadsheet by component 174.

A function engine can perform the calculation by receiving the logical definition of the formula which describes the function in terms of its objects and relationship between them and can then use this definition of the formula to process data received and thus calculate the result of the formula when provided with the input data.

The method of graphically defining a formula as defined by the present invention has a number of advantages. It provides a simple method of building a model based on a number of formulae that can be built using either top down or bottom up design methodology. The method can check to see that variable properties are inherited correctly and provide a warning if an error would result. The method provides an extremely versatile and simple method of creating multilevel models used to manipulate query data. The representations are easily understood and so the checking/auditing of the accuracy of a formula is more easily achieved.

As will be appreciated by the skilled addressee, modifications and variations can be made to the present invention without departing from the basic inventive concept, such as: various graphical user interface technologies can be used with this methodology, such as pull down menus, manipulation of graphics and information bubbles.

Such modifications and variations are intended to be within the scope of the present invention, the nature of which is to be determined from the foregoing description.

[image]

[image]

[image]

1. A computer-implemented method of graphically defining a formula, said method including:
providing a first operator object for defining a method of manipulating at least one input to produce at least one result;
displaying a graphical representation of the first operator object;
providing a first variable object for containing data;
receiving an input from a user to relate the variable object to one of the inputs or one of the results of the first operator object;
displaying a graphical representation of the first variable object and its relation to the first operator object; and
recording a logical description of the relationship between objects;
whereby the formula is defined by the logical description.

2. A computer-implemented method of graphically defining a formula, said method including:
providing a variable object for containing data;
displaying a graphical representation of the variable object;
providing a first operator object for defining a method of manipulating at least one input to produce at least one result;
receiving an input from a user to relate one of the inputs or one of the results of the first operator object to the variable object;
displaying a graphical representation of the operator object and its relation to the variable object; and
recording a logical description of the relationship between objects;
whereby the formula is defined by the logical description.

3. A computer-implemented method of graphically defining a formula, the method according to either claim 1 or claim 2, further includes the steps of:
providing one or more further variable objects;
receiving further inputs from the user to relate each further variable object to one of the inputs or one of the results of the first operator object;
displaying a graphical representation of the further variable objects and their relation to the operator object.

4. A method according to any one of claims 1, 2 or 3, wherein the method further includes the steps of:
providing one or more further operator objects;
receiving further inputs from the user to relate each variable objects to one of inputs or one of the results of the further operator objects;
displaying a graphical representation of the further operator objects and their relation to the variable objects.

5. A method according to any one of claims 1 to 4, wherein each variable object is selected from: an input object for providing data from a data source; an output object to provide data to a data destination; or a connection object for passing data from one operator object or another.

6. A method according to any one of claims 1 to 5, wherein a connection object represented as a link between the operator objects.

7. A method according to any one of claims 1 to 6, wherein each variable object may be provided with a variable label.

8. A method according to any one of claims 1 to 7, wherein each operator object may be provided with a operator label.

9. A method according to any one of claims 1 to 8, wherein the logical description of the formula is defined by the logical relationship between the objects.

10. A method according to any one of claims 1 to 9, wherein a graphical definition of the formula is recorded that defines the graphical display of the relationship between objects.

11. A method according to any one of claims 1 to 10, wherein the method includes the step of storing information describing the logical definition.

12. A method according to any one of claims 1 to 10, wherein the method includes the step of storing information describing the graphical definition.

13. A method according to any one of claims 1 to 12, wherein two or more related operator objects may be grouped such that the grouping defines a grouping operator object, wherein variable objects crossing the border of the grouping and connecting to inputs of operator objects in the group become the inputs of the grouping object component and variable objects crossing the border of the grouping and connecting to results of the operator objects in the group become results of the grouping operator object.

14. A method according to claim 13, wherein inputs and results of operator objects in the group not linked to another object become inputs and results, respectively, of the grouping operator object.

15. A method according to claim 13 or 14, wherein the graphical representation of the grouped objects is replaced by a graphical representation of the grouping operator object and the graphical representation of links to the contents of group are replaced with graphical representations of links to the representation of the grouping object.

16. A method according to claim 13 or 15, wherein the logical definition of the formula defined includes the contents of the grouping operator object.

17. A method according to claim 13 or 16, wherein the graphical definition of the overall formula displayed excludes the contents of the grouping operator object.

18. A method according to claim 13 or 17, wherein the contents of the grouping operator object may be graphically represented separately from the overall graphical representation of the formula.

19. A method according to any one of claims 1 to 18, wherein variable objects may be attributed with properties that define the type of data they can hold.

20. A method according to claim 19, wherein each input and result of an operator object may be attributed with properties that define the type of data that the operator object expects to receive and be able to produce, respectively.

21. A method according to claim 20, wherein a variable object may inherit the properties from the properties of another variable object that has already been defined and is related by an intervening operator object.

22. A method according to claim 20, wherein a variable object may inherit the properties from the properties of an operator object input or result that has already been defined and to which it is related.

23. A method according to any one of claims 19 to 22, wherein an input or result of an operation object may inherit the properties from the properties of a variable object that has already been defined and to which it is related.

24. A method according to any one of claims 19 to 23, wherein the method includes a step of checking that the properties of objects with already attributed which are being related match.

25. A method according to claim 7, wherein a library of labelled variable objects is predefined.

26. A method according to claim 8, wherein a library of labelled operator objects is predefined, each labelled operator object's method of manipulating its input/s to produce its result/s also being predefined.

27. A method according to claim 7 or 25, wherein the variable label of a variable object may be selected from a list of predefined variable labels.

28. A method according to claim 19, wherein each variable label may be attributed with properties that define the type of data a variable object labelled with the label can contain.

29. A method according to claim 19, wherein the selection of a variable label attributes the properties associated with the label to variable object.

30. A method according to claim 29, wherein the properties attributed to a variable object limit the selection of labels available to be selected.

31. A method according to any one of claims 1 to 30, wherein the operation object is at least one of addition, subtraction, multiplication, division, a look-up table and conditional operation.

32. A method according to any one of claims 1 to 30, wherein the operator object may be a multiple stage operation containing a plurality of simple operators linked to perform a more complex operator.

33. A method according to any one of claims 1 to 30, wherein in one form, the operator object is a query of the database.

34. A method according to any one of claims 1 to 30, wherein the first operator object performs a write to a database.

35. A method according to claim 8, wherein the operator label of an operator object may be selected from a list of predefined operator labels.

36. A method according to claim 35, wherein each operator label may be attribute with properties that define the type of data that inputs and results of a labelled operator object can receive or provide, respectively.

37. A method according to claim 36, wherein the selection of an operator label attributes the properties associated with the label to operator object.

38. A method according to claim 37, wherein the properties attributed to an operator object limit the selection of labels available to be selected.

39. A method according to any one of claims 1 to 38, wherein the logical definition may be used by a run time engine to put into operation the defined formula, wherein data provided to each variable object is linked to an input of an operator object, whereby the data becomes operands of the formula, each operator represented by the operator object becomes the operator of the formula and each result of the operator object becomes the next operand of the next operator or the final result/s of the formula, whereby computation of the formula can be conducted to produce a formula result.

40. A method according to any one. of claims 1 to 39, wherein a namespace may be defined for each variable, whereby the data in a logical variable represented by the variable object is the same for each occurrence of the variable object within the namespace.

41. A method according to claim 40, wherein the name space is by default global to the formula being modelled.

42. A method according to claim 40, wherein a logical connection is created between each occurrence of a labelled variable object within a namespace.

43. A method according to claim 40, wherein a graphical link may be displayed showing the logical connection between occurrences of labelled variable objects.

44. A method according to any one of claims 1 to 43, wherein a namespace may be defined for each operator object, whereby the operation of a logical operator represented by the operator object is the same for each occurrence of the operator object within the namespace.

45. A method according to claim 44, wherein the name space is by default global to the formula being modelled.

46. A method according to claim 13, wherein a grouped operator object may be used more than once with the definition of the grouped operator object being applied to the logical definition of the formula.

47. A method according to claim 19, wherein the properties of a label include type, units and dimension.

48. A method according to claim 10, wherein the graphical definition is described in XML.

49. A method according to any one of claims 1 to 48, wherein the logical definition is described in XML.

50. A method according to any one of claims 1 to 49, wherein each operator object includes a plurality of definitions of the operation performed by the operator represented by the operator object, each definition being for a separate type of data able to be manipulated by the operator.

51. A method according to any one of claims 1 to 50, wherein the operator object is graphically represented as a component having one or more inputs and one or more outputs, the component having an indicator representative of the operator represented.

52. A method according to any one of claims 1 to 51, wherein the operator object may be an empty component that is representative of a operator with methodology of manipulation inputs to produce results yet to be defined.

53. A method according to any one of claims 1 to 52, wherein the empty component is used to form criteria for searching for a suitable operator object that has a suitable defined methodology.

54. A method according to any one of claims 1 to 53, wherein a library of objects is provided.

55. A method according to any one of claims 1 to 53, wherein objects may be externally sourced.

56. A system for graphically defining a formula, comprising:
a computer including a display screen and a user input means;
means for providing a first operator object for defining a method of manipulating at least one input to produce at least one result;
means for displaying a graphical representation of the first operator object on the screen;
means for providing a variable object for containing data;
means for receiving an input from the user input means to relate the variable object to one of inputs or one of the results of the first operator object;
means for displaying a graphical representation of the first variable object and its relation to the operator object on the screen;
whereby the formula is defined by the relationship between the objects.

57. A computer program for controlling a computer for graphically defining a formula, said computer program causing the computer to undertake step including:
providing a first operator object for defining a method of manipulating at least one input to produce at least one result;
displaying a graphical representation of the first operator object on a computer screen;
providing a variable object for containing data;
receiving an input from a user input means to relate the variable object to one of inputs or one of the results of the first operator object;
displaying a graphical representation of the first variable object and its relation to the operator object on the screen;
whereby the formula is defined by the relationship between the objects.

58. A computer readable medium for storing a computer program as defined in claim 57.

59. A computer-implemented method of graphically defining a formula for manipulating input data to produce a result, said method including:
providing at least one variable for containing data;
providing at least one operator defining the method of manipulating the input data to produce the result;
displaying a list of the variables for a user to select a result variable therefrom;
receiving a selection of the result variable from the user for containing the result of the manipulation of the input data;
displaying a graphical representation of the selected result variable;
displaying a list of the operators for a user to select an operator therefrom;
receiving a selection of an operation from the user;
displaying a graphical representation of the selected operation;
displaying a list of inputs for containing the input data for a user to select at least one input therefrom, the inputs being either said variables or one or more constants;
receiving a selection of at least one input from the user;
displaying a graphical representation of the selected input,
whereby the formula is defined by the selected result variable being equal to the manipulation of selected input(s) by the selected operation.

60. A computer-implemented method of graphically defining a formula for manipulating input data to produce a result, said method including:
providing at least one variable type, said variable type having pre-determined properties;
providing at least one operation defining the method of manipulating the input data to produce the result;
displaying the variable types for a user to select a variable type therefrom;
receiving a selection of the variable type from the user;
receiving a name for the selected variable type;
displaying a representation of the named variable;
displaying a list of operations for a user to select an operation therefrom;
displaying a graphical representation of the selected operation;
receiving a selection of an operation from the user;
receiving input from the user so as to associate the selected variable with the selected operation so that the selected variable is either an input variable or a result variable;
where the selected variable is associated to be a result variable, receiving from the user a selection of at least one of either an input variable or an input constant and a name for the input variable or the input constant, displaying a graphical representation of the input variable(s) and/or input constant(s);
where the selected variable is an input variable, receiving a name for an output variable, displaying a graphical representation of the output variable;
whereby the formula is defined by the result of the manipulation by the selected operation of the input data in the input data variable or input constant provided to the result variable.
